(19) United States
(12) Patent Application Publication
(10) Pub. No.: US 2012/0065997 A1
(43) Pub. Date: Mar. 15, 2012

(54) Automatic Processing of Handwritten Physician Orders

(75) Inventors: Faisal Farooq, Norristown, PA (US); Romer E. Rosales, Downingtown, PA (US); Shipeng Yu, Exton, PA (US); Balaji Krishnapuram, King of Prussia, PA (US); Bharat R. Rao, Berwyn, PA (US)

(73) Assignee: SIEMENS MEDICAL SOLUTIONS USA, INC., Malvern, PA (US)

(21) Appl. No.: 13/228,776

(22) Filed: Sep. 9, 2011

Related U.S. Application Data
(60) Provisional application No. 61/381,089, filed on Sep. 9, 2010.

(51) Int. Cl. G06Q 50/22

(52) U.S. Cl. 705/3; 705/2

(57) ABSTRACT

Physician orders are automatically processed. Rather than requiring entry with a user interface in a computerized order entry system, physician orders may be handwritten on a piece of paper or entered on another handwriting device. The orders are scanned or transmitted. Using a lexicon limited to the vocabulary of possible orders, handwriting recognition is applied to the scanned order. By limiting the lexicon, the accuracy of the optical character recognition may be increased. The lexicon may be further limited by determining a diagnosis and/or treatment or imaging modality for the patient and selecting a lexicon limited to orders associated with the diagnosis or modality. The recognized order is then implemented by the computerized order entry system.

### RELATED APPLICATIONS

The present patent document claims the benefit of the filing date under 35 U.S.C. §119(e) of Provisional U.S. Patent Application Ser. No. 61/381,089, filed Sep. 9, 2010, which is hereby incorporated by reference.

### BACKGROUND

The present embodiments relate to physician order processing. Physicians order prescriptions, treatment, radiological scanning, lab tests, or other activities for patients. The orders may be handwritten.

Computerized physician order entry (CPOE) systems allow electronic entry of instructions for the treatment of patients. The orders are typed in or a user interface is used to select the appropriate order. These orders are communicated electronically to the medical staff or to the pharmacy, laboratory, or radiology staff. CPOE systems may decrease delay in order completion, reduce errors related to handwriting or transcription, allow order entry at point-of-care or off-site, provide error-checking for duplicate or incorrect doses or tests, and simplify inventory and posting of charges. CPOE systems may reduce preventable, potential adverse events. Despite this evidence, fewer than 5% of U.S. hospitals had fully implemented these systems by 2005. As of 2011, fewer than 25% are believed to have implemented CPOE systems. Handwritten orders may still be used in a majority of healthcare facilities. CPOE systems may take years to install and configure and the wide roll out has been slowed by resistance to changes in physician's practice patterns, costs and training time involved. Physicians may prefer handwritten orders, so resist implementation of CPOE.

### BRIEF SUMMARY

By way of introduction, the preferred embodiments described below include methods, computer readable media, and systems for automated processing of handwritten physician orders. Rather than requiring entry with a user interface in a computerized physician order entry system, physician orders may be handwritten on a piece of paper. The orders are scanned. Using a lexicon limited to the vocabulary of possible orders, optical character recognition is applied to the scanned order. By limiting the lexicon, the accuracy of the optical character recognition may be increased. The lexicon may be further limited by determining a diagnosis and/or treatment or imaging modality for the patient and selecting a lexicon limited to orders associated with the diagnosis or modality. The recognized order is then implemented by the computerized physician order entry system.

In a first aspect, a method is provided for automated processing of handwritten physician orders. A prescription from a physician is scanned. The prescription is handwritten on paper. The scanned prescription is received in a computerized order entry system. A processor of the computerized order entry system applies character recognition to the scanned prescription from the physician. The character recognition uses a lexicon limited to approved medications. The applying matches the handwritten prescription to one of the approved medications. The matched medication is communicated to an order fulfillment system.

In a second aspect, a non-transitory computer readable storage medium has stored therein data representing instructions executable by a programmed processor for automated processing of handwritten physician orders. The storage medium includes instructions for identifying a diagnosis or modality for a patient, establishing a lexicon as a function of the diagnosis or modality, the lexicon limited to a vocabulary of the physician orders, receiving an image of one of the handwritten physician orders, recognizing the one of the handwritten physician orders as being for one of the physician orders of the vocabulary, and arranging for fulfillment of the one of the physician orders.

In a third aspect, a system is provided for automated processing of handwritten physician orders. A memory is operable to store a list of orders for physicians. A processor is configured to adapt a lexicon to the list, constrain character recognition based on the lexicon as adapted to the list, identify a first order of a physician in a handwritten order with the constrained character recognition, and export the first order to a computerized physician order entry system.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a flow chart diagram of an embodiment of a method for automated processing of handwritten physician orders;

FIG. 2 is a graphical illustration of another embodiment of a method for automated processing of handwritten physician orders; and

FIG. 3 is a block diagram of one embodiment of a system for automated processing of handwritten physician orders.

### DETAILED DESCRIPTION OF THE DRAWINGS AND PRESENTLY PREFERRED EMBODIMENTS

Handwritten prescriptions and/or other orders are fulfilled based on optical character recognition (OCR), intelligent character recognition (ICR), and/or handwriting recognition (HR) technology. These terms are used interchangeably herein. A computer system identifies orders in order to automate the workflow for physician order entry. By allowing handwritten orders in the process of order entry and fulfillment based on handwriting recognition technology, CPOE systems may be more widely implemented.

Handwriting recognition (HR) in the field of Optical Character Recognition (OCR) may operate well for constrained tasks. Postal automation and bank check processing use handwriting recognition. HR may be more successful due to a constrained and fixed number of possible words (called lexicons). Automatic transcription of handwriting may be more accurate for smaller lexicons. Handwriting recognition technology may be applied to recognize physician orders. The text (i.e., handwritten words) in physician orders, such as prescriptions, belongs to a fixed vocabulary (e.g., an approved medication list). This knowledge is used to fix the lexicons that drive the recognition of the handwriting and enable automatic transcription of the orders.

A physician may continue to create handwritten orders, reducing training and dealing with resistance to change. With HR, electronic communication and quick fulfillment that resembles a CPOE and also does not involve the time, money and training required by successful implementation of CPOEs may be provided.

The lexicons may be further reduced in an automated fashion. The modality, diagnosis, and other related data for the patient to which the order applies is determined and used to reduce the lexicon. For example, some medications cannot be prescribed for certain diagnoses or only certain known medications may be prescribed for a particular modality. This knowledge further reduces the size of the lexicon list and hence may improve the accuracy of HR.

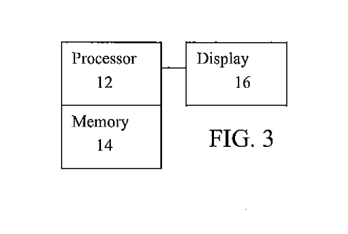

FIG. 1 shows a method for automated processing of handwritten physician orders. The method is implemented by a CPOE system, an automated workflow system, a review station, a workstation, a computer, a PACS station, a server, combinations thereof, or other system in a medical facility. For example, the system or computer readable media shown in FIG. 3 implements the method, but other systems may be used.

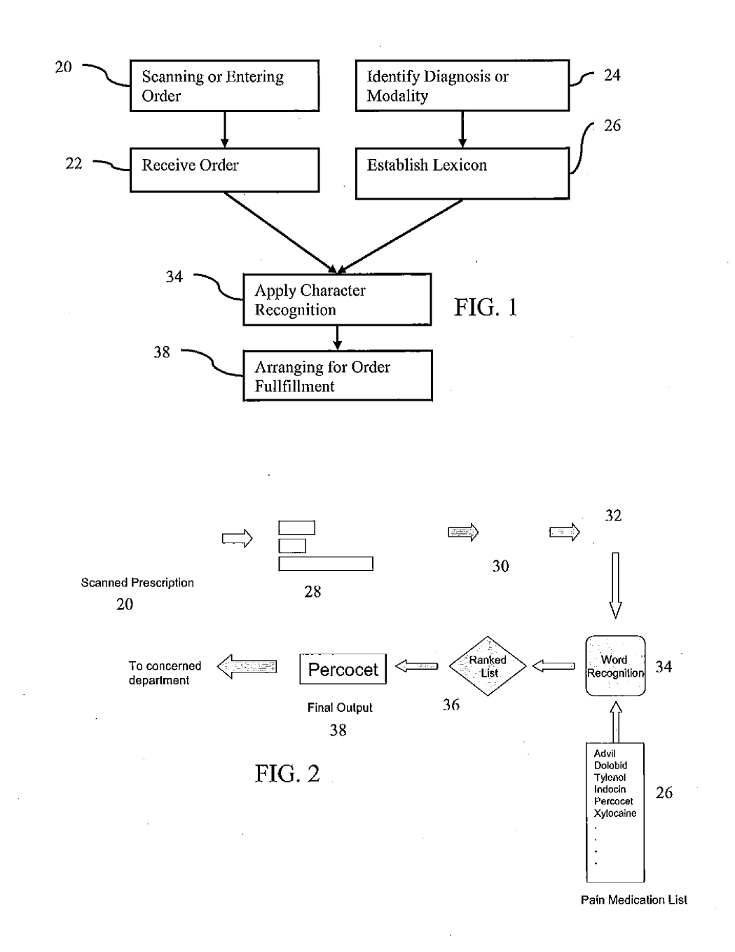

Additional, different, or fewer acts may be performed. For example, act 22 is provided as part of act 20. Act 24 may not be provided. Additional acts, such as acts 28, 30, 32, and 36 represented in FIG. 2, may be provided.

The method is implemented in the order shown or a different order. Acts 20 and 22 are performed in parallel, before, or after acts 24 and 26.

In act 20, an order is entered. A physician provides instructions for the treatment or diagnosis of a patient. The order is entered as handwritten. For example, the physician writes a prescription or instructions for radiology on a piece of paper. FIG. 2 shows an example handwritten pharmacy order on a prescription form. As another example, the physician writes the order on a tablet computer or other electronic device. Rather than typing in or selecting text, the entry is in the form of handwriting, such as entering print or cursive characters with a finger or stylus.

For electronically entered handwritten orders, the handwritten order is entered into the automated order processing system. Alternatively, the handwritten order is transmitted to the automated order processing system. The handwritten order is an image of the order. Any format may be provided for the image.

For paper orders, the handwritten order is scanned. For example, a nurse or assistant scans the order at a nurses' station or other network access point in a medical facility. The scan results in an image of the handwritten order. The image is a copy of the scanned order.

In act 22, the handwritten order is received by the order processing system. For example, the scanned order is received into the order processing system through the act of scanning. The scanning user interface may be for the order processing system. Alternatively, the scanned image of the order is transmitted to the order processing system, such as transmitted to a remote server. As another example, the electronic handwritten order is received by entry into or by transmission to the order processing system. In other embodiments, the order processing system retrieves the image of the order from a memory.

The order processing system is implemented on a local computer, such as attached to a scanner. Alternatively, the order processing system is implemented on a networked server or computer. The system receives the image or copy of the handwritten order for applying handwriting recognition. By transferring the physician order (e.g., a scanned prescription for medication) to the server, the server may process the order.

In act 24, a diagnosis or modality for a patient is identified. Any information specific to the patient, including allergies, symptoms, or other treatments may be used instead of or with the diagnosis or modality. The modality is of an imaging, treatment, or other system. For example, the modality refers to a radiology system, of which there are different modes. Positron emission tomography, single photon emission computed tomography, x-ray, computed tomography, ultrasound, and magnetic resonance imaging are some example modalities. These modalities may be used for treatment and/or diagnostic imaging. Different modalities are associated with different possible orders.

The diagnosis or modality associated with the physician order is determined. For example, the computerized patient record of the patient is searched. A diagnosis code may be found in the search. Billing codes or other information may indicate a diagnosis or modality. As another example, the diagnosis or modality is mined from the computerized patient record. Any data mining may be used, such as disclosed in U.S. Published Patent Application No. 2003/0120458.

In one example, the order is entered and received for a particular patient. As part of inputting the handwritten order, the patient is indicated. A nurse or assistant may enter or select the patient associated with the handwritten order when input. The order processing system searches the medical record for the patient to identify the most recent diagnosis, modality or both. Alternatively, the diagnosis or modality is entered with the order.

In another embodiment, the diagnosis, modality and/or patient identification is indicated on the handwritten physician order. Character recognition or other process is used to extract the diagnosis, modality, and/or patient identifier.

In act 26, the lexicon is established. The lexicon is a vocabulary of words. The lexicon may include common misspellings and/or different forms of the same word (e.g., plural, singular, present tense, and past tense).

The lexicon is established based on the patient, medical facility, general use in the medical field, physician, department, specific field, or other grouping. For example, a lexicon is provided for all possible physician orders. The lexicon includes medications by generic, scientific, chemical, and/or trade name. The lexicon includes modality information, such as types of imaging or treatment available for each mode. The lexicon includes treatment terms, lab or testing terms, and/or radiology terms. The lexicon may have additional, different, or fewer types of words.

The lexicon may be specific to a medical facility. For example, a given hospital may have only certain types of modalities or may only treat certain types of patients, limiting the medications. The lexicon may be specific to a physician, department, or other grouping.

In one embodiment, the lexicon adapts as a function of the extracted diagnosis or modality of the patient to which the order applies. A library of lexicons is provided, such as a different lexicon for each possible diagnosis or modality. The terms appropriate for the specific diagnosis or modality are included in the lexicon and other terms are not. For example, a patient diagnosed with influenza would only receive a small subset of all medications for treating the influenza. The lexicon to be used is based on this vocabulary. The vocabulary of words related to the diagnosis is limited. The appropriate lexicon is selected.

Handwriting recognition is applied in act 28. FIG. 2 shows one example, but other approaches may be used. A processor of the order processing (e.g., computerized order entry) system applies the handwriting recognition. The image of the handwritten order received in act 22 is analyzed by the processor. For example, handwriting recognition is applied to a scanned prescription.

To recognize the handwritten order, such as the name of the medication, dosage, treatment, or test, the appropriate terms are located in act 28 from the handwritten order. Where the handwriting is entered on a computerized from, the extraction occurs merely by isolating the handwriting or separate words. Where the handwriting was scanned, the appropriate words for performing the order are extracted. Any technique may be used. For example, a template is provided to mask parts of the order representing a form. The remaining area is analyzed to identify separate words, such as fitting boxes around spatially separate handwriting.

In act 30, one or more words are extracted. The handwriting associated with each word is separated or segmented. Gradient or low pass filtering may be used to remove any outlier information or noise. In one embodiment, the box or other shape fit to the word in act 22 defines the region to be segmented.

In act 32, the individual letters of the word are segmented or separated. Spatial separation or character recognition may be applied to separate out the letter. Separating the letters of the word allows for independent letter recognition, further limiting the lexicon available to twenty-six letters with or without numbers of symbols. The letters and word matches with the limited lexicon may have greater accuracy. In alternative embodiments, the word recognition is applied on a word scale so letters are not separated.

In act 34, any now known or later developed handwriting recognition is applied. The handwriting recognition is holistic or analytical, word based or character based, and/or segmentation based or segmentation free. The underlying techniques may involve hidden markov models, neural networks, dynamic programming, or other approaches. Where the handwriting was performed digitally rather than scanned, further information for recognition may be provided. Velocity, stroke directions and lengths, pen ups and pen downs or other characteristics of the act of writing may be used in addition to the image of the handwriting.

Based on the lexicon established in act 26, the handwriting recognition may be limited. The character recognition is constrained by the vocabulary of physician orders, such as constrained to a list of medications. Any recognition applied at a letter level may not be constrained by the lexicon for physician orders unless there are letters, numbers, or symbols not used in the word lexicon. At the word level, the available options for the handwritten word are limited to words in the lexicon. Using a fixed vocabulary, the accuracy of matching the handwriting to words may be increased.

The vocabulary is fixed during application. Words associated with different physician orders may be added to or removed from the lexicon to keep the list up to date. For example, the lexicon is limited to medications associated with a particular diagnosis or modality (see FIG. 2 for an example medication list at act 26). The lexicon is limited to the medications associated with diagnosis or modality. When a new medication is available or another medication is not longer to be used, the lexicon is changed according.

The application of the handwriting recognition results in the handwritten physician order being matched to a word in the lexicon or limited vocabulary. Some forms of character recognition use probabilities, distances, or other scoring. For example, the handwritten word is matched to more than one word, but with different probabilities of the match being correct. In act 36, a ranked list is provided. The ranking is by probability, distance, or score, but other rankings may be used. Where the highest ranked word is above a threshold level, such as 50% or more probability, the word may be selected for output. In alternative embodiments, the handwritten order is recognized as a single word in the lexicon without ranking.

A result of the application of the handwriting recognition is a matched word or words. For example, the handwritten prescription is matched to a word (e.g., “Percocet”®) in the lexicon. The word is used as the physician order. Dosage may also be matched using a limited lexicon.

In act 38, fulfillment of the one of the physician orders is arranged. Since the handwritten order is known by matching, the order may be processed using any approach to automated or computerized physician order entry. Checks may be performed, such as avoiding duplication, identifying any contraindications, or verifying within dosage tolerances. The checks are automated.

One example check is by a human. The check is performed by personnel associated with or by the physician. The medical staff verify that the order match is correct. After any local checks, the matched medication or other order is provided to an order fulfillment system. Alternatively, the check is performed by personnel receiving or implementing the order.

In one embodiment, as soon as a handwritten physicians order is entered, a workflow is started and the nurse station, pharmacy, radiology department or other personal or system is notified of the order. The person responsible for allocating resources or scheduling may confirm the order by visual inspection. The image is available along with the order recognized from the image of the handwriting. In the case where the person decides to change the order, the other options in the ranking of act 36 may be presented to the user. The user may select one of the ranked options. Alternatively, the user may input the order by viewing the image and without selecting one of the options output by the handwriting recognition.

The matched medication and a patient name are communicated to an order fulfillment system. Any order fulfillment system may be used. For example, the order fulfillment system is a pharmacy system. A prescription to be filled is transmitted to the pharmacy system for dispensing the medication. Another example may be a radiology department system. The order for scheduling a treatment, diagnostic imaging, or test is transmitted to the radiology system for scheduling. In another example, a lab or testing system receives the order for scheduling a test.

The order fulfillment system may be implemented on a same or different network than the order processing system. In one embodiment, the order processing and order fulfillment systems are parts of a same system.

FIG. 3 shows a system for automated processing of handwritten physician orders. The system is a server, network, workstation, computer, database, or combinations thereof. The system 10 includes a processor 12, a memory 14, and a display 16. Additional, different, or fewer components may be provided. For example, the system includes a scanner, a network connection, a wireless transceiver or other device for receiving handwritten orders and/or communicating orders to other systems. A wireless transceiver may allow for communication with a physician's mobile device. The physician may write the order on a mobile device outside the hospital or medical facility setting. The order may be received and processed (recognition applied) in or outside of the medical facility setting. For example, a physician writes an order on a mobile device while in a hospital or at home. The handwritten order is transmitted to a server outside or in the hospital, such as a server for or at a pharmacy, and the server applies the handwriting recoginition.

The memory 14 is a buffer, cache, RAM, removable media, hard drive, magnetic, optical, database, or other now known or later developed memory. The memory 14 is a single device or group of two or more devices. The memory 14 is shown within the system, but may be outside or remote from other components of the system, such as a database or PACS memory.

The memory 14 stores a list of orders for physicians. One list is stored for a given medical facility, institution, or for all uses. Alternatively, multiple lists are stored. The lists are different, such as including different orders. Different lexicons are used for different medical facilities, departments, physicians, diagnosis, modality, or other factors.

The list is of words associated with orders. For example, the list includes all possible or known orders written by physicians. As another example, the list may be limited to any practice area or other grouping, such as diagnosis or modality based lists. The list is created by analysis of previous orders, medical ontology, or other process.

The memory 14 is additionally or alternatively a non-transitory computer readable storage medium with processing instructions. The memory 14 stores data representing instructions executable by the programmed processor 12 for automated processing of handwritten physician orders. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The processor 12 is a server, general processor, digital signal processor, graphics processing unit, application specific integrated circuit, field programmable gate array, digital circuit, analog circuit, combinations thereof, or other now known or later developed device for applying handwriting recognition. The processor 12 is a single device, a plurality of devices, or a network. For more than one device, parallel or sequential division of processing may be used. Different devices making up the processor 12 may perform different functions, such as a handwriting detector by one device and a separate device for communicating or processing the detected order. In one embodiment, the processor 12 is a control processor or other processor of a computerized physician order entry system. The processor 12 operates pursuant to stored instructions to perform various acts described herein.

The processor 12 is configured by software or hardware to adapt a lexicon to a list. The lexicon is formed from a list of possible orders or orders that a physician may or typically writes by hand. The lexicon adapts to this list as the possible orders change. Over time, the standard of care or guidelines for care may change. With this change is a change in the orders provided by physicians. The list of orders is different, so the lexicon adapts to the list. The change in the lexicon is programmed by a user, entered by a user, updated by a user, or a mined by a processor.

The processor 12 is configured to constrain character recognition based on the lexicon as adapted to the list. The handwriting recognition may rely on matching words. By only comparing the handwriting to words on the list, the variability or options for a given handwritten word are reduced. Such reduction may increase accuracy in recognition.

The processor 12 is configured to identify an order of a physician in a handwritten order. Using the constrained lexicon, the processor 12 applies the handwriting recognition algorithm. The handwriting recognition operates without training, is trained in general, or is trained based particular physician and/or medical facility samples. Training to a specific physician or group of physicians may make the recognition more accurate. The trained character recognition is applied to orders by a physician, department, medical facility or other group.

The processor 12 is configured to export the order to a computerized physician order entry system. The recognized order is used for order fulfillment. The export may be from the recognition to a fulfillment part of the same system.

The display 16 is a CRT, LCD, plasma, projector, printer, or other output device for showing an image. The display 16 displays a user interface with an image. The user interface may be for the entry of information, such as entry of handwritten orders via a touch screen. The user interface may be for the scanning of handwritten orders on paper. In other embodiments, the user interface is for verification of proper order recognition and/or order fulfillment operations.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. A method for automated processing of handwritten physician orders, the method comprising:
scanning a prescription from a physician, the prescription handwritten on paper;
receiving the scanned prescription in a computerized order entry system;
applying, by a processor of the computerized order entry system, character recognition to the scanned prescription from the physician, the character recognition using a lexicon limited to approved medications, the applying matching the handwritten prescription to one of the approved medications; and
communicating the matched medication to an order fulfillment system.

2. The method of claim 1 wherein scanning the prescription comprises scanning at a nurse's station.

3. The method of claim 1 wherein receiving the scanned prescription comprises transferring the scanned prescription from a scanner to a server of the computerized order entry system.

4. The method of claim 1 wherein applying comprises applying with the character recognition constrained to the approved medications.

5. The method of claim 1 wherein the approved medications comprises a fixed vocabulary.

6. The method of claim 1 wherein applying comprises applying the character recognition with a fixed vocabulary, the fixed vocabulary being based on an identity of a physician or medical facility.

7. The method of claim 1 further comprising:
determining a diagnosis or modality associated with the prescription; and
limiting the lexicon to the medications associated with the diagnosis or modality;
wherein applying comprises applying with the lexicon limited to the medications associated with the diagnosis or modality.

8. The method of claim 7 wherein determining comprises mining a computerized patient medical record for the diagnosis or modality.

9. The method of claim 7 wherein determining comprises identifying the diagnosis or modality from the paper.

10. The method of claim 1 wherein communicating comprises communicating the matched medication and a patient name to a pharmacy system.

11. The method of claim 1 wherein communicating comprises scheduling an appointment with a radiology system.

12. In a non-transitory computer readable storage medium having stored therein data representing instructions executable by a programmed processor for automated processing of physician orders, the storage medium comprising instructions for:
identifying a diagnosis or modality for a patient;
establishing a lexicon as a function of the diagnosis or modality, the lexicon limited to a vocabulary of the physician orders;
receiving an image of one of the physician orders;
recognizing the one of the physician orders as being for one of the physician orders of the vocabulary; and
arranging for fulfillment of the one of the physician orders.

13. The non-transitory computer readable storage medium of claim 12 wherein identifying the diagnosis or modality comprises identifying a treatment or imaging modality.

14. The non-transitory computer readable storage medium of claim 12 wherein identifying comprises obtaining the diagnosis or modality from an electronic medical record of the patient.

15. The non-transitory computer readable storage medium of claim 12 wherein establishing comprises selecting the vocabulary as a list of medications.

16. The non-transitory computer readable storage medium of claim 12 wherein receiving the image comprises receiving a scanned copy of the physician orders.

17. The non-transitory computer readable storage medium of claim 12 wherein recognizing comprises applying handwriting recognition constrained by the vocabulary.

18. The non-transitory computer readable storage medium of claim 12 wherein arranging comprises scheduling pursuant to the one physician order or providing for dispensing of a prescription medication.

19. The non-transitory computer readable storage medium of claim 12 wherein arranging comprises generating a workflow in response to the receiving.

20. The non-transitory computer readable storage medium of claim 12 wherein receiving comprises receiving from handwriting on a device and wherein recognizing comprises recognizing as a function of a characteristic of how the physician order was written.

21. The non-transitory computer readable storage medium of claim 12 wherein receiving comprises receiving from a wireless transmission, the receiving being outside a medical facility or the applying being outside the medical facility.

22. A system for automated processing of handwritten physician orders, the system comprising:
a memory operable to store a list of orders for physicians; and
a processor configured to adapt a lexicon to the list, constrain character recognition based on the lexicon as adapted to the list, identify a first order of a physician with the constrained character recognition, and export the first order to a computerized physician order entry system.

23. The system of claim 22 wherein the processor is configured to update the list.
